(19) United States
(12) Patent Application Publication
(10) Pub. No.: US 2025/0060650 A1
(43) Pub. Date: Feb. 20, 2025

(54) NONLINEAR OPTICAL CRYSTAL STRUCTURE

(71) Applicant: PEKING UNIVERSITY, Beijing (CN)

(72) Inventors: Kaihui LIU, Beijing (CN); Hao HONG, Beijing (CN); Chenjun MA, Beijing (CN); Chen HUANG, Beijing (CN); Enge WANG, Beijing (CN)

(73) Assignee: PEKING UNIVERSITY, Beijing (CN)

(21) Appl. No.: 18/721,288

(22) PCT Filed: Apr. 21, 2023
(86) PCT No.: PCT/CN2023/089869

§ 371 Date: Jun. 18, 2024

(30) Foreign Application Priority Data
Nov. 23, 2022 (CN) 202211475627.3

(51) Int. Cl. G02F 1/355; G02F 1/35; G02F 1/37

(52) U.S. Cl. CPC G02F 1/3551; G02F 1/3501; G02F 1/3534; G02F 1/37

(57) ABSTRACT

A nonlinear optical crystal structure is provided. The nonlinear optical crystal structure includes a plurality of two-dimensional material films, wherein the plurality of two-dimensional material films are stacked in a direction perpendicular to a two-dimensional plane thereof, and two-dimensional material films adjacent to each other are bonded by van der Waals forces, each of the plurality of two-dimensional material films is a crystal with a center-inversion-asymmetric crystal structure, and has a predetermined lattice orientation parallel to the two-dimensional plane in a direction parallel to the two-dimensional plane, there is a non-zero twist angle between the two-dimensional material films adjacent to each other, and the twist angle is an included angle between predetermined lattice orientations of the two-dimensional material films adjacent to each other in the same two-dimensional plane, and a thickness of each of the plurality of two-dimensional material films is greater than 5 nm.

### CROSS-REFERENCE TO RELATED APPLICATION

The present application claims priority to Chinese Patent Application No. 202211475627.3 filed on Nov. 23, 2022, the disclosure of which is incorporated herein by reference in its entirety as a part of the present application.

### TECHNICAL FIELD

Embodiments of the present disclosure relate to a nonlinear optical crystal structure.

### BACKGROUND

The research of nonlinear optics truly began in 1961, when Franken used a laser with a wavelength of 694 nm to pass through crystal quartz and discovered the generation of coherent output light with a wavelength of 347 nm. This was the first experiment of second harmonic generation in nonlinear optics. Thereafter, with the maturity of laser technology and the further establishment of nonlinear optics theory, the field of nonlinear optics has become a hot research topic.

Nonlinear optical crystals are the core of laser technologies such as optical frequency conversion, pulse compression, ultra-high power lasers, and supercontinuum laser generation, etc., and are widely used in fields such as laser communication and LiDAR, etc. With the development of optical technology, exploring new optical crystal systems to meet the needs of high-tech innovation is the key to develop advanced laser technology and devices. At present, mature nonlinear optical crystals include BaB₂O₄ (BBO), KBeBOF₂ (KBBF), LiNbO₃ (LN), and so on. However, in order to meet the rapid development of modern information communication, high-precision industries, and industrial construction, it is urgent to explore a new generation of miniaturized, broadband, and high-power laser technology, as well as a new generation of high-performance optical crystals.

### SUMMARY

Although the existing nonlinear optical crystals can achieve the output of nonlinear light, in order to meet the needs of constantly developing information communication and other high-precision industries, the enhancement efficiency of nonlinear light needs to be further improved. In order to solve the above problems, the embodiments of the present disclosure provide a nonlinear optical crystal structure as described below.

An embodiment of the disclosure provides a nonlinear optical crystal structure, comprising a plurality of two-dimensional material films, wherein the plurality of two-dimensional material films are stacked in a direction perpendicular to a two-dimensional plane thereof, and two-dimensional material films adjacent to each other are bonded by van der Waals forces, each of the plurality of two-dimensional material films is a crystal with a center-inversion-asymmetric crystal structure, and has a predetermined lattice orientation parallel to the two-dimensional plane in a direction parallel to the two-dimensional plane, there is a non-zero twist angle between the two-dimensional material films adjacent to each other, and the twist angle is an included angle between predetermined lattice orientations of the two-dimensional material films adjacent to each other in the same two-dimensional plane, and a thickness of each of the plurality of two-dimensional material films is greater than 5 nm.

In some examples, a wave-vector mismatch of a second-order nonlinear optical effect of the two-dimensional material film is Δk, and the nonlinear optical crystal structure comprises N two-dimensional material films, wherein a twist angle θₘ of an m-th two-dimensional material film relative to a first two-dimensional material film satisfies:

$$\frac{11}{60} Δ k ( {\sum }_{n = 1}^{m} {t}_{n} - \frac{1}{2} {t}_{m} - \frac{1}{2} {t}_{1} ) \leq {θ}_{m} \leq \frac{29}{60} Δ k ( {\sum }_{n = 1}^{m} {t}_{n} - \frac{1}{2} {t}_{m} - \frac{1}{2} {t}_{1} ) ,$$

where tₙ is a thickness of an n-th two-dimensional material film, tₘ is a thickness of the m-th two-dimensional material film, t₁ is a thickness of the first two-dimensional material film, N is an integer greater than or equal to 2, n is an integer greater than or equal to 1 and less than or equal to N, and m is an integer greater than 1 and less than or equal to N.

In some examples, the plurality of two-dimensional material films are equal in thickness and each has a thickness t, and the twist angle θₘ of the m-th two-dimensional material film relative to the first two-dimensional material film satisfies:

$$\frac{11}{60} ( m - 1 ) Δ k \cdot t \leq {θ}_{m} \leq \frac{29}{60} ( m - 1 ) Δ k \cdot t .$$

In some examples, the thickness of each of the plurality of two-dimensional material films is less than or equal to a coherence length l_{c}, and the coherence length l_{c} is a characteristic distance of enhancement of nonlinear light in the crystal with the center-inversion-asymmetric crystal structure.

In some examples, the twist angle between the two-dimensional material films adjacent to each other is less than or equal to 60 degrees.

In some examples, a thickness of at least one of the plurality of two-dimensional material films is greater than a coherence length l_{c}, and the coherence length l_{c} is a characteristic distance of enhancement of nonlinear light in the crystal with the center-inversion-asymmetric crystal structure.

In some examples, a twist direction of the m-th two-dimensional material film relative to a (m⁻¹)-th two-dimensional material film is the same for every value of m.

In some examples, a total thickness of the plurality of two-dimensional material films is an integer multiple of a coherence length l_{c}, the coherence length l_{c} is a characteristic distance of enhancement of nonlinear light in the crystal with the center-inversion-asymmetric crystal structure, and the twist angle between the two-dimensional material films adjacent to each other is:

$$θ = Δ k \cdot t / 3.$$

In some examples, at least two of the plurality of two-dimensional material films have different thicknesses, and the twist angle θₘ further satisfies:

$${θ}_{m} = Δ k ( {\sum }_{n = 1}^{m} {t}_{n} - \frac{1}{2} {t}_{m} - \frac{1}{2} {t}_{1} ) / 3 ,$$

and thicknesses of the plurality of two-dimensional material films satisfy:

$${\sum }_{p = 1}^{N} exp ( - 2 i Δ k {\sum }_{n = 1}^{p - 1} {t}_{n} ) [ exp ( - i Δ k \frac{3}{2} {t}_{p} ) - exp ( - i Δ k \frac{1}{2} {t}_{p} ) ] = 0 ,$$

where p is an integer greater than or equal to 1 and less than or equal to N, and tₚ is a thickness of a p-th two-dimensional material film.

In some examples, the wave-vector mismatch Δk is in a range from 10³ to 10⁹ m⁻¹.

In some examples, the thickness of each of the plurality of two-dimensional material films is substantially equal to a coherence length l_{c}, the coherence length l_{c} is a characteristic distance of enhancement of nonlinear light in the crystal with the center-inversion-asymmetric crystal structure, and the twist angle between the two-dimensional material films adjacent to each other is in a range from 51 degrees to 69 degrees.

In some examples, each of the plurality of two-dimensional material films has a crystal structure with a threefold rotational symmetry.

In some examples, each of the plurality of two-dimensional material films comprises a plurality of sub-layers, each of the plurality of sub-layers has a same crystal structure with a parallel orientation, the plurality of sub-layers comprise a first type sub-layer and a second type sub-layer, chemical bonds formed between atoms at corresponding lattice positions of the first type sub-layer and the second type sub-layer are in opposite directions, and a count of films of the first type sub-layers is greater than a count of films of the second type sub-layers; or chemical bonds formed between atoms at corresponding lattice positions of the plurality of sub-layers are all in a same direction.

In some examples, the count of films of the first type sub-layers accounts for more than 60% of a total count of films of the plurality of sub-layers.

In some examples, a second-order nonlinear optical coefficient of the crystal with the center-inversion-asymmetric crystal structure is not less than 0.01 pm/V.

In some examples, a material of the plurality of two-dimensional material films comprises any one selected from the group consisting of boron nitride, transition metal chalcogenide, palladium selenide, niobium oxide diiodide or niobium oxide dichloride.

In some examples, the second-order nonlinear optical effect comprises second harmonic generation, sum frequency generation and difference frequency generation.

In some examples, the coherence length l_{c} is less than 1 mm.

In some examples, the twist angle is configured to simultaneously compensate the wave vector mismatch of second harmonic generation and sum frequency generation.

According to the embodiments of the present disclosure, a nonlinear enhancement optical crystal structure is constructed by stacking thick two-dimensional material films and using parameters such as twist angle, film thickness and stacking, etc., so that high-efficiency output of second-order nonlinear light, such as second harmonic generation, sum frequency generation or difference frequency generation, etc., as well as other nonlinear light, can be easily achieved.

### BRIEF DESCRIPTION OF DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1A is a schematic structural diagram of a nonlinear optical crystal structure according to some embodiments of the present disclosure;

FIG. 1B is a schematic diagram showing twist angles between different two-dimensional material films;

FIG. 2A is a schematic structural diagram of a nonlinear optical crystal structure according to some embodiments of the present disclosure;

FIG. 2B is a schematic diagram of a simulation result of enhancement efficiency of second harmonic generation (SHG) of a nonlinear optical crystal structure according to some embodiments of the present disclosure;

FIGS. 3A and 3B are schematic diagrams showing simulation results of enhancement efficiency of second harmonic generation (SHG) of a nonlinear optical crystal structure at different angles under corresponding twist-phase matching conditions according to some embodiments of the present disclosure;

FIG. 4 is a schematic diagram showing a simulation result enhancement efficiency of second harmonic generation (SHG) of nonlinear optical crystal structures with different two-dimensional material film thicknesses under corresponding twist-phase matching conditions according to some embodiments of the present disclosure;

FIG. 5A is a schematic structural diagram of a nonlinear optical crystal structure according to some embodiments of the present disclosure;

FIG. 5B is a schematic diagram showing the twist angle between adjacent films and the thickness of the nonlinear optical crystal structure as shown in FIG. 5A;

FIG. 6A is a schematic structural diagram of polarization control of second harmonic generation of a nonlinear optical crystal structure according to some embodiments of the present disclosure; and

FIG. 6B is an experimental result diagram of polarization of second harmonic generation of a nonlinear optical crystal structure according to some embodiments of the present disclosure.

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

Unless otherwise specified, the technical terms or scientific terms used in the disclosure shall have normal meanings understood by those skilled in the art. The word “comprise”, “include” or the like used in the disclosure only indicates that an element or a component before the word contains elements or components listed after the word and equivalents thereof, not excluding other elements or components.

In the embodiments of the disclosure, the features such as “parallel”, “vertical” and “same” used herein include the strict meaning of “parallel”, “vertical”, “same”, etc., as well as “substantially parallel”, “substantially vertical”, “substantially same”, etc., which include a certain degree of error, taking into account the measurement and errors related to the measurement of specific quantities (e.g., limitations of the measurement system), which represent the acceptable deviations within the range determined by ordinary technicians in the field for specific values. For example, “substantially” can mean within one or more standard deviations, or within 10% or 5% of the value. When the quantity of a component is not specifically indicated in the following description of this embodiment, it means that the component can be one or more, or can be understood as at least one. “At least one” means one or more, and “more than one” means at least two.

In nonlinear optics, the nonlinear response of materials is described by polarization, and under the action of optical field, the electrical polarization in the dielectric can be described as:

$$P = {ε}_{0} [ {χ}^{( 1 )} E + {χ}^{( 2 )} {E}^{2} + {χ}^{( 3 )} {E}^{3} + … {χ}^{( n )} {E}^{n} ] ,$$

where ε₀χ⁽¹⁾E is a linear term, other perturbation terms are nonlinear terms, χ⁽ⁿ⁾ is an n-order nonlinear susceptibility. The micro mechanisms that generate nonlinear polarization mainly include electron cloud distortion, molecular rotation and vibration, and rearrangement of molecular orientation, etc.

The second-order nonlinear optical effect only occurs in crystals with inversion asymmetry (inversion symmetry breaking), and the corresponding nonlinear coefficient tensor is χ⁽²⁾. The second-order polarization intensity can be expressed as:

$${P}^{( 2 )} = {\sum }_{m , n} {ε}_{0} {χ}^{( 2 )} ( - ω , {ω}_{m} , {ω}_{n} ) : E ( {ω}_{m} ) E ( {ω}_{n} ) .$$

In the embodiment of the present disclosure, a nonlinear optical crystal that achieves a quadratic nonlinear optical effect will be described as an example. For example, the second-order nonlinear optical effect includes second harmonic generation, sum frequency generation and difference frequency generation.

The second harmonic generation means that when the incident light is monochromatic light with frequency ω, it is called fundamental frequency light, and after the incident light passes through a nonlinear dielectric (e.g., a nonlinear optical crystal), frequency-doubled light with frequency 2ω will be produced. In the case of undepleted pump approximation and not considering the walk-off effect, the intensity of the second harmonic generation can be written as:

$${I}_{2 ω} = \frac{2 {ω}^{2}}{{c}^{3} {n}^{2} ( ω ) n ( 2 ω ) {ε}_{0}} {d}_{eff}^{2} {I}_{ω}^{2} {L}^{2} \frac{{sin}^{2} ( Δ kL / 2 )}{{( Δ kL / 2 )}^{2}} ,$$

where I_{2ω}, and I_{ω} are the intensity of the frequency-doubled light and the intensity of the fundamental frequency light, respectively; L is the transmission distance of the fundamental frequency light in the nonlinear crystal, d_{eff} is the second-order nonlinear coefficient, Δk is the wave-vector mismatch,

$$Δ k = \frac{4 π}{λ} ( n ( 2 ω ) - n ( ω ) ) ,$$

λ is the wavelength of the incident light; generally, Δk≠0, and therefore, the phase mismatch effect may occur in a traditional nonlinear crystal. When the second harmonic generation undergoes phase mismatch, every coherence length l_{c}

$$( {l}_{c} = \frac{π}{Δ k} = \frac{λ}{4 ( n ( 2 ω ) - n ( ω ) )} )$$

is passed the energy of the fundamental frequency light and the energy of the frequency-doubled light will be reversed, and the second harmonic generation cannot be effectively enhanced. The coherence length l_{c} refers to a characteristic distance at which the nonlinear light can be enhanced in the crystal, and l_{c}=π/Δk. The wave-vector mismatch Δk is related to the wavelength of the light and the type of the optical crystal. The coherence length l_{c} and the wave-vector mismatch Δk in the following description have the same meaning, which will not be repeated.

The sum frequency generation means that two incident beams of light with frequencies ω1 and ω2, respectively, after passing through a nonlinear dielectric, will generate sum-frequency light with a frequency of ω3=ω1+ω2. In the case of undepleted pump approximation and not considering the walk-off effect, the intensity of the sum-frequency light can be written as:

$${I}_{3} = \frac{2 {ω}_{3}^{2}}{{c}^{3} n ( {ω}_{1} ) n ( {ω}_{2} ) n ( {ω}_{3} ) {ε}_{0}} {d}_{eff}^{2} {I}_{1} {I}_{2} {L}^{2} \frac{{sin}^{2} ( Δ kL / 2 )}{{( Δ kL / 2 )}^{2}} ,$$

where I₁, I₂ and I₃ are the intensity of the incident light with frequency ω1, the intensity of the incident light with frequency ω2 and the intensity of the sum-frequency light, respectively; L is the transmission distance of the incident light in the nonlinear crystal, d_{eff} is the second-order nonlinear coefficient of the sum frequency generation, Δk is the wave-vector mismatch,

$$Δ k = 2 π ( \frac{n ( {ω}_{1} )}{{λ}_{1}} + \frac{n ( {ω}_{2} )}{{λ}_{2}} - \frac{n ( {ω}_{3} )}{{λ}_{3}} ) ,$$

λ is the wavelength of the incident light; generally, Δk≠0, and therefore, the phase mismatch effect may occur in a traditional nonlinear crystal. When the sum frequency generation undergoes phase mismatch, every coherence length l_{c}

$$( {l}_{c} = \frac{π}{\vert Δ k \vert} = \frac{1}{2} \frac{1}{\vert \frac{n ( {ω}_{1} )}{{λ}_{1}} + \frac{n ( {ω}_{2} )}{{λ}_{2}} - \frac{n ( {ω}_{3} )}{{λ}_{3}} \vert} )$$

is passed the energy of the incident light and the energy of the sum-frequency light is reversed, and the sum-frequency light cannot be output efficiently.

The difference frequency generation means that two incident beams of light with frequencies ω1 and ω2, respectively, after passing through a nonlinear dielectric, will generate difference-frequency light with a frequency of ω3=ω1−ω2. The difference frequency generation is the fundamental principle of optical parametric amplifiers and optical parametric oscillators. Therefore, optical crystals that can efficiently generate difference-frequency light can be used to manufacture optical parametric amplifiers and optical parametric oscillators. In the case of undepleted pump approximation and not considering the walk-off effect, the intensity of the difference-frequency light can be written as:

$${I}_{3} = \frac{2 {ω}_{3}^{2}}{{c}^{3} n ( {ω}_{1} ) n ( {ω}_{2} ) n ( {ω}_{3} ) {ε}_{0}} {d}_{eff}^{2} {I}_{1} {I}_{2} {L}^{2} \frac{{sin}^{2} ( Δ kL / 2 )}{{( Δ kL / 2 )}^{2}} ,$$

where I₁, I₂ and I₃ are the intensity of the incident light with frequency ω1, the intensity of the incident light with frequency ω2 and the intensity of the difference-frequency light, respectively; L is the transmission distance of the incident light in the nonlinear crystal, d_{eff} is the second-order nonlinear coefficient of the difference frequency generation, Δk is the wave-vector mismatch,

$$Δ k = 2 π ( \frac{n ( {ω}_{1} )}{{λ}_{1}} - \frac{n ( {ω}_{2} )}{{λ}_{2}} - \frac{n ( {ω}_{3} )}{{λ}_{3}} ) ,$$

λ is the wavelength of the incident light; generally, Δk≠0, and therefore, the phase mismatch effect may occur in a traditional nonlinear crystal. When the difference frequency generation undergoes phase mismatch, every coherence length l_{c}

$$( {l}_{c} = \frac{π}{\vert Δ k \vert} = \frac{1}{2} \frac{1}{\vert \frac{n ( {ω}_{1} )}{{λ}_{1}} - \frac{n ( {ω}_{2} )}{{λ}_{2}} - \frac{n ( {ω}_{3} )}{{λ}_{3}} \vert} )$$

is passed, the energy of the incident light and the energy of the difference-frequency light is reversed, and the difference-frequency light cannot be output efficiently.

In order to overcome the problem that the second harmonic generation, sum-frequency light and difference-frequency light cannot be output efficiently due to phase mismatch, a quasi-phase matching method can be adopted. For example, the quasi-phase matching can use periodically polarized nonlinear optical crystals to effectively enhance the second harmonic generation. The advantage of the quasi-phase matching is that it does not require specific polarization and angle conditions to be met, and at the same time, it can make use of the maximum effective nonlinear coefficient of the nonlinear crystal. The quasi-phase matching only requires phase compensation of 180 degrees to be introduced when every coherence length is passed, so as to achieve the effective enhancement of the second harmonic generation. The period of the polarization reversal introduced can also be an odd multiple of the coherence length. In nonlinear optics, the reciprocal lattice vector can be used to describe the phase mismatch compensated by the periodic structure, that is, Gₘ=2πm/Λ, where Λ=2l_{c} is the length of one period. Constructing a suitable nonlinear crystal structure with periodic polarization reversal is the key to achieve the quasi-phase matching. The traditional crystal materials used for quasi-phase matching are generally lithium niobate (LiNbO₃) etc., and periodically polarized nonlinear optical crystals with specific ripple structures can be obtained by Czochralski growth method or electric field pattern polarization method. Recently, laser pulse polarization technology has also been developed. In the quasi-phase matching, every coherence length is passed, the polarization direction of the dielectric is reversed, so that the intensity of the second harmonic generation can be continuously enhanced. The quasi-phase matching can also be used to output the sum-frequency light and the difference-frequency light with high efficiency.

However, the preparation of periodically polarized crystals by quasi-phase matching requires complicated equipment and complicated processes, and polarization units can only be arranged in both positive and negative directions, thus limiting the functional application of traditional periodically polarized nonlinear optical crystals.

Two-dimensional single crystal materials have silicon-based compatible processing technology, quantum tunable physical properties, and ultra-high nonlinear coefficients, making them ideal materials for optical crystals. At the same time, there are many kinds of two-dimensional single crystal materials, including a wide range of systems such as conductors, semiconductors, insulators, and magnets, etc. In some two-dimensional materials with central symmetry breaking, strong second-order nonlinear effect can be generated. Compared with traditional crystal materials, two-dimensional materials have advantages such as high nonlinearity, high damage threshold, and wide spectrum, etc. Therefore, two-dimensional materials are ideal materials for nonlinear optical crystals.

Some embodiments of the present disclosure provide a nonlinear optical crystal structure, which includes a plurality of two-dimensional material films. The plurality of two-dimensional material films are stacked in a direction perpendicular to a two-dimensional plane thereof, and two-dimensional material films adjacent to each other are bonded by van der Waals forces; each of the plurality of two-dimensional material films is a crystal with a center-inversion-asymmetric crystal structure, and has a predetermined lattice orientation parallel to the two-dimensional plane in a direction parallel to the two-dimensional plane; there is a non-zero twist angle between the two-dimensional material films adjacent to each other, and the twist angle is an included angle between predetermined lattice orientations of the two-dimensional material films adjacent to each other in the same two-dimensional plane; and a thickness of each of the plurality of two-dimensional material films is greater than 5 nm.

The nonlinear optical crystal structure according to the embodiment of the present disclosure achieves ultra-efficient nonlinear optical frequency conversion by adjusting the parameters, such as stacking, thickness and twist angle, etc., of two-dimensional materials, which is also the key technology in the field of laser frequency doubling. In addition, the polarization of the second harmonic generation can be adjusted according to the parameters such as twist angle, etc., so as to achieve the functional application of optical crystals. For example, two-dimensional materials with high nonlinear coefficient cans achieve phase matching of second-order nonlinear optical effects, including second harmonic generation, sum frequency generation and difference frequency generation, through the selection of material types, preparation of thick-film two-dimensional materials, and tuning of film thickness and twist angle of thick-film material stacking, and finally achieves high-efficiency output of optical nonlinear light and adjustment of polarization state of nonlinear signals. The nonlinear optical crystal structure of the embodiment of the present disclosure utilizes the advantages of two-dimensional materials with richer degrees of freedom (twist angle of stacking and types of stacking materials) and finer tuning means (atomic level longitudinal stacking accuracy), so the preparation process thereof is more refined, with higher adjustment freedom and more accurate processing technology, which makes the crystal more sensitive to tuning of light, and can easily achieve significant enhancement of second-order nonlinear light such as second harmonic generation, and easily achieve tuning of polarization.

Hereinafter, the technical solutions of the present disclosure will be described in more detail according to some specific embodiments of the present disclosure, so as to make the technical solutions of present disclosure more clear.

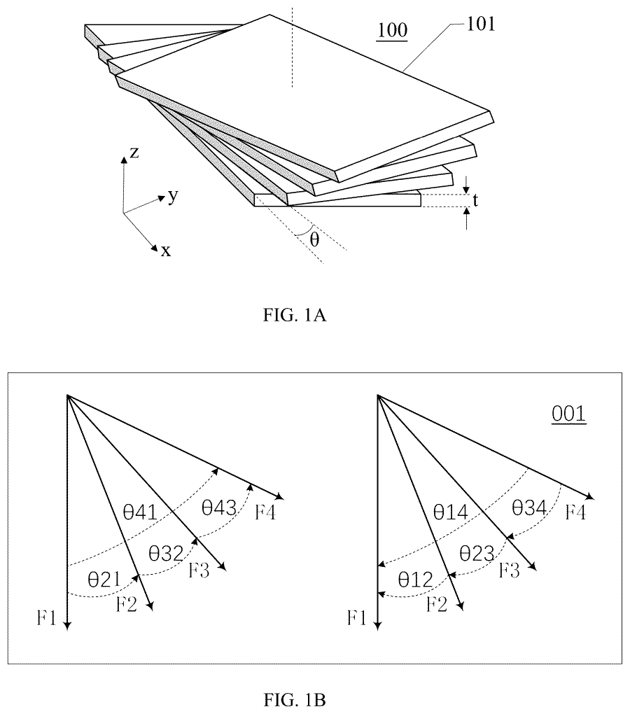

FIG. 1A is a schematic structural diagram of a nonlinear optical crystal structure according to some embodiments of the present disclosure. As shown in FIG. 1A, the nonlinear optical crystal structure 100 according to some embodiments of the present disclosure includes a plurality of two-dimensional material films 101. For example, each two-dimensional material film 101 includes a two-dimensional plane extending in the X direction and the Y direction, the plurality of two-dimensional material films 101 are stacked in the direction (the Z direction) perpendicular to the two-dimensional plane, and two-dimensional material films 101 adjacent to each other are bonded by van der Waals forces. Each two-dimensional material film 101 is a crystal with a center-inversion-asymmetric crystal structure, and has a predetermined lattice orientation parallel to the two-dimensional plane of the two-dimensional material film 101 in a direction parallel to the two-dimensional plane. There is a non-zero twist angle θ between two-dimensional material films 101 adjacent to each other. The twist angle θ is an included angle between the predetermined lattice orientations of two-dimensional material films 101 adjacent to each other in the same two-dimensional plane. In addition, the thickness t of each two-dimensional material film 101 is greater than 5 nm.

Here, the two-dimensional material film has a center-inversion-asymmetric (or called inversion symmetry breaking) crystal structure, which is the basis for realizing the nonlinear optical effect. For example, the two-dimensional material film itself can be a two-dimensional material film formed by growing or stacking a plurality of sub-layers, and each sub-layer in the two-dimensional material film has the same crystal structure and a parallel orientation. The plurality of sub-layers include a first type sub-layer and a second type sub-layer, chemical bonds formed between atoms at corresponding lattice positions of the first type sub-layer and the second type sub-layer are in opposite directions, and the number of films of the first type sub-layers is greater than the number of films of the second type sub-layers; or chemical bonds formed between atoms at corresponding lattice positions of the plurality of sub-layers are all in the same direction, so that the crystal structure of the two-dimensional material film as a whole is a center-inversion-asymmetric crystal structure. For example, the “corresponding lattice position” mentioned above means that a lattice position in one sub-layer is shifted along the stacking direction of the sub-layers to another film by an integer multiple of the lattice constant in this direction, or further shifted along a direction in the plane of the sub-layers by a distance less than the maximum size in the lattice plane, so as to obtain another lattice position which is the corresponding lattice position of the original lattice position. For another example, for two vertex positions on a certain side of a hexagon, the two vertex positions on that side after being shifted are the corresponding positions of the original two vertex positions. For example, if a chemical bond is formed in a certain direction between a boron atom and a nitrogen atom distributed at two lattice positions in one sub-layer, and a chemical bond between a boron atom and a nitrogen atom distributed at two corresponding lattice positions in another sub-layer is oriented in an opposite direction, then the chemical bonds formed between atoms at corresponding lattice positions in the two sub-layers are in opposite directions; if a chemical bond is formed in a certain direction between a boron atom and a nitrogen atom distributed at two lattice positions in one sub-layer, and a chemical bond between a boron atom and a nitrogen atom distributed at two corresponding lattice positions in another sub-layer is also oriented in this direction, then the chemical bonds formed between atoms at the corresponding lattice positions in the two sub-layers are in the same direction. It should be noted that the number of films of the first type sub-layers being greater than the number of films of the second type sub-layers can be that the number of films of the first type sub-layers accounts for more than 60% of the total number of films of the plurality of sub-layers, so that the two-dimensional material film exhibits more pronounced nonlinear optical effects. For example, the above ratio can be greater than 70%, greater than 80% or greater than 90%. For example, each sub-layer mentioned above can be an atomic film. For another example, the sub-layers mentioned above are also bonded to each other by van der Waals forces.

As described above, each two-dimensional material film 101 is a crystal with a center-inversion-asymmetric crystal structure, and any suitable nonlinear optical crystal with nonlinear optical effect can be used as the crystal with the center-inversion-asymmetric crystal structure here. For example, the material of the two-dimensional material film can include any one or more selected from the group consisting of boron nitride, transition metal chalcogenide, palladium selenide, niobium oxide diiodide or niobium oxide dichloride. For another example, the transition metal chalcogenide can include molybdenum disulfide, tungsten disulfide, tungsten selenide, molybdenum selenide, molybdenum telluride, tungsten telluride, etc.

In the nonlinear optical crystal structure according to the embodiment of the present disclosure, the material of each two-dimensional material film can be the same. However, the embodiment of the present disclosure is not limited to this case, and at least two two-dimensional material films among the plurality of two-dimensional materials can be made of different materials.

For example, in the embodiment of the present disclosure, two-dimensional material films adjacent to each other are bonded by van der Waals forces, and it is not limited to the case where there is only van der Waals forces between the two bonded surfaces, as long as they are bonded mainly by van der Waals forces. The bonding by van der Waals forces not only is convenient to realize the stacking process, but also does not affect the tuning of nonlinear light phase matching, thus improving the output efficiency of nonlinear light.

For example, there is a non-zero twist angle between the two-dimensional material films 101 adjacent to each other, meaning that there is a certain degree of twist angle between the crystal structures of two-dimensional material films adjacent to each other in the plane. The twist angle is defined by using the included angle between predetermined lattice orientations of the two-dimensional material films 101 adjacent to each other in the same two-dimensional plane; the predetermined lattice orientation here is not limited to a particular lattice orientation of the crystal structure, but the same lattice orientation is selected for different two-dimensional material films, so that the twist angle between the crystal structures of different two-dimensional material films in the plane can be determined by the included angle between the predetermined lattice orientations of different two-dimensional material films. For example, the predetermined lattice orientations of different two-dimensional material films 101 can be projected into a plane parallel to the two-dimensional material films, and the included angle between the projections of different predetermined lattice orientations is the above twist angle.

For example, for a hexagonal boron nitride structure, the [0001] lattice orientation of its crystal structure can roughly coincide with the stacking direction Z of the two-dimensional material films, and the predetermined lattice orientation in the two-dimensional plane can be any one of the lattice orientations in the plane perpendicular to the stacking direction, such as [010], [120], [1̅100], etc. Of course, the lattice orientations listed here are all exemplary. As long as the same lattice orientation is selected when evaluating the twist angle of the stacking of the two-dimensional material films, the twist angle between different two-dimensional material films can be accurately obtained. Therefore, this lattice orientation is called the predetermined lattice orientation here, and those skilled in the art can understand its meaning. In addition, the hexagonal boron nitride structure described above is also exemplary, and the embodiment of the present disclosure is not limited to the crystal structure, materials and various lattice orientations described above.

As described above, in the embodiment of the present disclosure, the thickness t of each two-dimensional material film 101 is greater than 5 nm. Although the stacking of two-dimensional material films with relatively small thickness can improve the output efficiency of nonlinear light, the stacking of two-dimensional material films with very thin thickness (as thin as monoatomic layer in extreme cases) cannot well achieve high output efficiency. As will be described in more detail below, for the nonlinear optical crystal structure formed by stacking two-dimensional crystal material films according to the embodiment of the present disclosure, in order to obtain higher output efficiency of nonlinear light, the twist angle and the thickness of each film can be adjusted in combination. In the case where the thickness is very small, the twist angle will also be very small, and the angle application range that satisfies the enhancement of output efficiency of nonlinear light will also be very small, which causes great difficulty in the processing techniques and may result in loss of the output efficiency of nonlinear light in the case of low manufacturing accuracy. The inventors of the present disclosure have found that when the thickness of each two-dimensional material film is greater than 5 nm, by stacking two-dimensional material films with such thickness, high-efficiency output, process reliability and convenience can be balanced.

It should be noted that although the output efficiency of light can be greatly improved by adjusting the twist angle and the thickness of each film, as long as there exists a non-zero twist angle in the stacking of thick two-dimensional material films according to the embodiment of the present disclosure, the wave-vector mismatch of the nonlinear light can be compensated to a certain extent. Therefore, the output efficiency of the nonlinear light can be improved to a certain extent.

In the embodiment of FIG. 1A described above, it is shown that the nonlinear optical crystal structure includes four two-dimensional material films; however, the number of films of the two-dimensional material films here is only exemplary. According to needs, the number of films of the two-dimensional material films in the nonlinear optical crystal structure is not limited to this case, but there may be more or less two-dimensional material films. For example, two, three, five or more two-dimensional material films may be included.

For the above twist angle, it will be further explained with reference to FIG. 1B, so as to make its meaning more clear. For example, the selected predetermined lattice orientations F1, F2, F3 and F4 of the four two-dimensional material films in FIG. 1A are projected into the same plane 001 parallel to the two-dimensional material films. As shown on the left side of FIG. 1B, F2 twists counterclockwise relative to F1 by 021, F3 twists counterclockwise relative to F2 by 032, F4 twists counterclockwise relative to F3 by 043, and F4 twists counterclockwise relative to F1 by 041. From another perspective, as shown on the right side of FIG. 1B, F1 twists clockwise relative to F2 by 012, F2 twists clockwise relative to F3 by 023, F3 twists clockwise relative to F4 by 034, and F1 twists clockwise relative to F4 by 014. For example, with reference to FIG. 1B, the second film twists counterclockwise relative to the first film, the third film twists counterclockwise relative to the second film, and the fourth film twists counterclockwise relative to the third film. For this stacking mode, the twist direction is unchanged. This stacking mode can be called continuous twist-angle stacking mode. The above description of the twist angle, although illustrated in combination with the clockwise or counterclockwise direction, is merely exemplary. It can be understood that one direction can have a rotation of 360 degrees in the plane, and considering the rotational symmetry (e.g., threefold rotational symmetry) for nonlinear optical crystals, the above definition of the twist direction may be more meaningful at a smaller angle, for example, within a range of twist angle of less than 60 degrees, but the embodiment of the present disclosure is not limited thereto. Although a better technical effect can be achieved by combining a specific twist mode and an adjusted range of twist angle (which will be described in more detail in the following embodiments), some embodiments of the present disclosure do not limit the twist direction between the adjacent two-dimensional material films.

It should be noted that the two-dimensional material films of the nonlinear optical crystal structure may have the same thickness or different thicknesses. According to the embodiments of the present disclosure, there is no particular limitation on this matter.

For example, the two-dimensional material film can adopt crystal materials with group D₆ₕ or C₃ᵥ. For example, hexagonal boron nitride (h-BN) can be used as the material of the two-dimensional material film.

For example, in the nonlinear optical crystal structure according to some embodiments of the present disclosure, the stacking direction of the two-dimensional material films is parallel to one rotation axis of the crystal structure of the two-dimensional material films. For example, for hexagonal boron nitride, the stacking direction can be parallel to the [0001] lattice orientation.

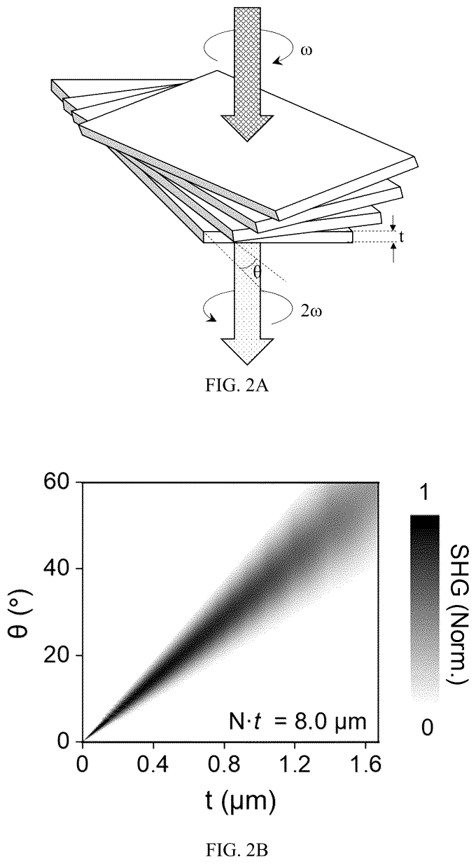

In some embodiments, as shown in FIG. 2A, the nonlinear optical crystal structure adopts a continuous twist-angle structure and the thickness of each two-dimensional material film is the same. For example, the nonlinear optical crystal structure includes N two-dimensional material films, and the thickness of each two-dimensional material film is t, then the total thickness of the nonlinear optical crystal structure is N·t. The twist angle of the m-th film relative to the first film is θₘ=(m−1)θ, where N is an integer greater than or equal to 2, m is a positive integer greater than or equal to 2 and less than or equal to N, and θ is equal to the twist angle of the second film relative to the first film. It should be noted that the sequential number of the two-dimensional material films described here and below is counted sequentially from one side of the nonlinear optical crystal structure along the stacking direction of the two-dimensional material films. For example, in FIG. 1B, the first two-dimensional material film, the second two-dimensional material film, the third two-dimensional material film, and the fourth two-dimensional material film can be sequentially counted from bottom to top. Of course, the embodiment of the present disclosure is not limited to this case, and for example, it can also be sequentially counted from top to bottom in FIG. 1B. In these embodiments, the thickness of each two-dimensional material film is the same, and the twist angle between every two adjacent films is the same.

In order to obtain the influence of different periodic angles θ and film thicknesses t on the second-order nonlinear optical effect such as second harmonic generation, the inventors of the present disclosure have conducted research and experiments on this matter. Firstly, the total thickness T (T is equal to the sum of the thicknesses of N two-dimensional material films used to construct the nonlinear optical crystal structure, as an example, T=8 μm) is controlled to be the same, and then the final enhancement intensity is obtained by simulating and calculating according to the coupled nonlinear wave equations under the condition of continuous twist angle. FIG. 2B is a schematic diagram of a simulation result of enhancement efficiency of second harmonic generation of a nonlinear optical crystal structure according to some embodiments of the present disclosure. As can be seen from FIG. 2B, in the case where 3θ=Δk·t, the output efficiency of the second harmonic generation is enhanced to the maximum. In this case, corresponding to the twist-phase matching enhancement conditions, it can be seen at the same time that the smaller the thickness t, the higher the enhancement efficiency of the second harmonic generation.

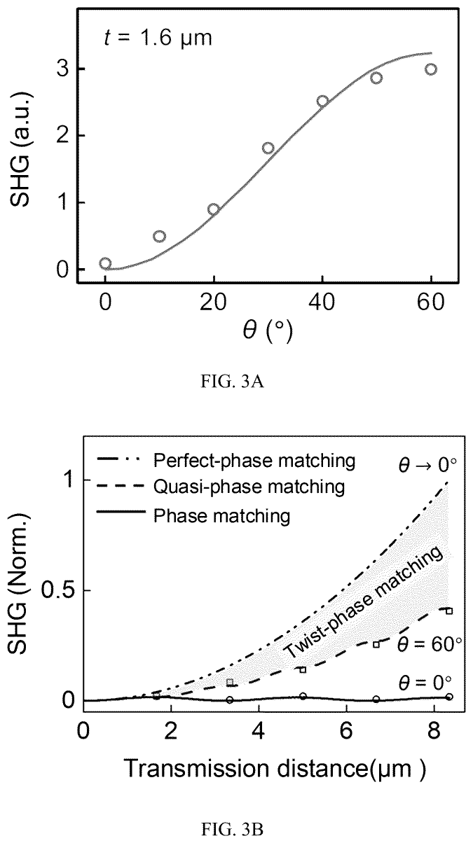

FIGS. 3A and 3B are schematic diagrams showing simulation results of enhancement efficiency of second harmonic generation (SHG) of a nonlinear optical crystal structure at different angles under corresponding twist-phase matching conditions according to some embodiments of the present disclosure. In the embodiment shown in FIG. 3A, two hexagonal boron nitride (hBN) two-dimensional material films, each of which has a thickness equal to the coherence length l_{c}, are adopted, and the dependence of the intensity of second harmonic generation on the twist angle is obtained by adjusting the twist angle between the two two-dimensional material films. As shown on the left side of FIG. 3A, for hBN whose thickness is equal to the coherence length l_{c}, the conversion efficiency of second harmonic generation is the highest when the twist angle is 60 degrees, which corresponds to quasi-phase matching. FIG. 3B shows a continuous twist-angle structure of hBN formed by five two-dimensional material films, in which the twist angle is not 60 degrees. In these embodiments, the enhancement efficiency of second harmonic generation is simulated by adjusting the corresponding twist angle with the thickness of the two-dimensional material film. By solving the coupled nonlinear wave equations, it is found that the final output intensity of second harmonic generation is between that of perfect-phase matching and that of quasi-phase matching (the gray part in FIG. 3B). This mode can be called twist-phase matching. When the thickness t and the twist angle approach zero, the twist-phase matching tends to be perfect-phase matching. Furthermore, based on calculation, the curve between the conversion efficiency of the second harmonic generation and the thickness t under the condition of twist-phase matching is obtained. In the case where the twist angle is 30 degrees, the conversion efficiency is twice that of quasi-phase matching, so that the second harmonic generation is effectively enhanced.

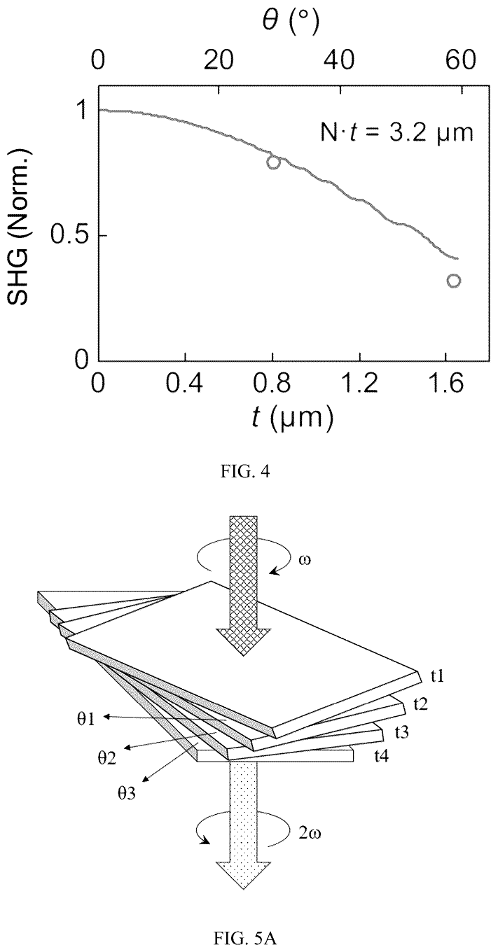

FIG. 4 is a schematic diagram showing a simulation result enhancement efficiency of second harmonic generation (SHG) of nonlinear optical crystal structures with different two-dimensional material film thicknesses under corresponding twist-phase matching conditions according to some embodiments of the present disclosure. In the embodiment shown in FIG. 4, the total thickness T is adjusted to 3.2 μm, and the relationship between the output efficiency of two-dimensional nonlinear light and different combination of the thickness t of the two-dimensional material film and the twist angle θ between adjacent two-dimensional material films is obtained. It can also be seen from FIG. 4 that with the decrease of the thickness of each single film of the two-dimensional material films, higher enhancement efficiency of second harmonic generation can also be obtained.

Based on the simulation results of FIG. 2B, FIG. 3A, FIG. 3B and FIG. 4, it can be seen that when the thickness of the two-dimensional material film is gradually reduced and the twist angle is accordingly changed, the conversion efficiency of second harmonic generation will gradually increase, and the conversion efficiency will be between the conversion efficiency of quasi-phase matching and the conversion efficiency of perfect-phase matching. However, under the condition of the same thickness, the range of twist angle θ required to obtain the twist-phase matching enhancement will gradually decrease with the decrease of the thickness of the two-dimensional material film (for example, see the width of the black part in FIG. 2B). As described above, the inventors have also found that with the decrease of the thickness of the two-dimensional material film, the precision requirement for the twist angle increases for the twist-phase matching enhancement. This will have an impact on both preparation and effects. First, when the thickness is very small, the range of twist angle that needs to be cooperatively adjusted is also very small, which poses high requirements for the precision of controlling the thickness of the two-dimensional material film and the precision of controlling the twist angle when stacking the two-dimensional material films; second, due to the above-mentioned strict requirements for precision, the preparation errors adversely affect the output efficiency of nonlinear light of the prepared nonlinear optical crystal structure. The inventors of the present invention have found through experiments that when stacking thick two-dimensional material film with a thickness greater than 5 nm, good enhancement of the output efficiency of second-order nonlinear light can be easily achieved.

For example, the continuous twist-angle structure of the nonlinear optical crystal structure can realize twist-phase matching under the excitation of circularly polarized light. Under the continuous twist-angle structure, when the condition of 3θ=Δk·t is satisfied, the efficiency of second harmonic generation excited by circularly polarized light is four times that excited by linearly polarized light, and the smaller the twist angle, the smaller the corresponding film thickness, and the higher the conversion efficiency of second harmonic generation, sum frequency generation or difference frequency generation. Theoretically, the perfect-phase matching condition can be realized under the continuous twist-angle condition, with an efficiency π²/4 that of quasi-phase matching.

In the above embodiments, the thickness t of each two-dimensional material film is the same. However, the embodiments of the present disclosure are not limited thereto. The thicknesses t of the two-dimensional material films in the nonlinear optical crystal structure according to the embodiment of the present disclosure can also be different.

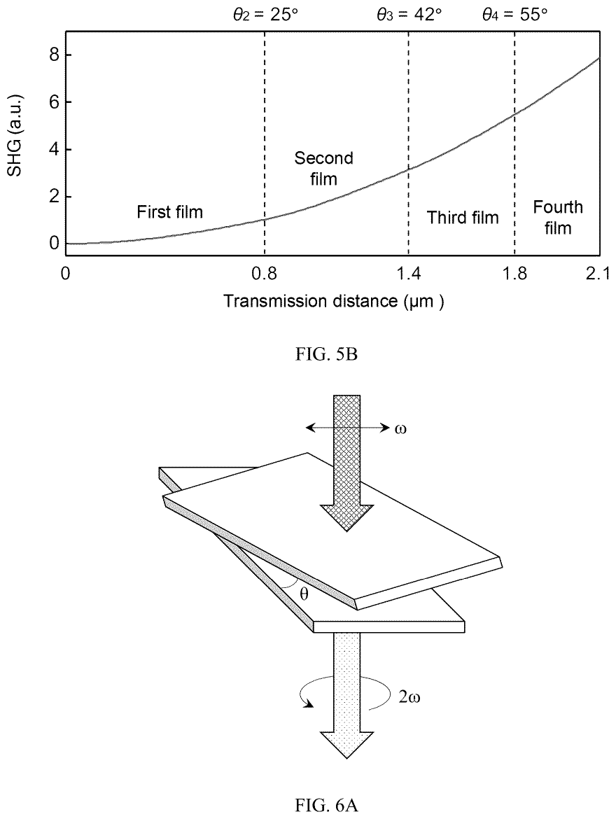

FIG. 5A is a schematic structural diagram of a nonlinear optical crystal structure according to some embodiments of the present disclosure; FIG. 5B is a schematic diagram showing the twist angle between adjacent films and the thickness of the nonlinear optical crystal structure as shown in FIG. 5A. As shown in FIG. 5A, the nonlinear optical crystal structure is also a continuous twist-angle structure. From top to bottom in FIG. 5A, the thicknesses of the first to fourth two-dimensional material films are t1, t2, t3 and t4, respectively. As shown in FIG. 5B, the thickness t1 of the first two-dimensional material film is 0.8 μm, the thickness t2 of the second two-dimensional material film is 0.6 μm, the thickness t3 of the third two-dimensional material film is 0.4 μm, and the thickness t4 of the fourth two-dimensional material film is 0.3 μm. Therefore, light is incident from the first two-dimensional material film, and the transmission distances when it reaches the surfaces of the first, second, third and fourth two-dimensional material films away from the light incident side are 0.8 μm, 1.4 μm, 1.8 μm and 2.1 μm, respectively. The twist angle θ1 between the first two-dimensional material film and the second two-dimensional material film is 25 degrees, the twist angle θ2 between the second two-dimensional material film and the third two-dimensional material film is 42 degrees, and the twist angle θ3 between the third two-dimensional material film and the fourth two-dimensional material film is 55 degrees. In these embodiments, by adjusting the twist angles between two-dimensional material films with different thicknesses, the high output efficiency of second-order nonlinear light between quasi-phase matching and perfect-phase matching can also be achieved, and the enhancement of the output efficiency of second-harmonic generation can be achieved.

As can be seen from FIGS. 5A and 5B, in the embodiment where two-dimensional material films with different thicknesses are stacked, the output efficiency of the second harmonic generation can be enhanced by adjusting the twist angle between adjacent two-dimensional material films according to the thicknesses of the two-dimensional material films. The inventors of the present invention have found through experiments that when a continuous twist-angle structure is used to stack N two-dimensional material films in a nonlinear optical crystal structure, the twist angle of the m-th film relative to the first film satisfies:

$${θ}_{m} = Δ k ( {\sum }_{n = 1}^{m} {t}_{n} - \frac{1}{2} {t}_{m} - \frac{1}{2} {t}_{1} ) / 3 ,$$

so that the output efficiency of second-order nonlinear light can be enhanced and the twist-phase matching can be achieved. The output efficiency of second-order nonlinear light in this case is between that of quasi-phase matching and that of perfect-phase matching. Here, t1 is the thickness of the first two-dimensional material film, N is an integer greater than or equal to 2, n is an integer greater than or equal to 1 and less than or equal to N, and m is an integer greater than 1 and less than or equal to N.

As can be seen from the results in FIGS. 5A and 5B, compared with the strict requirements of quasi-phase matching for the film thickness t, one or more corresponding values of θₘ can be found for any value of film thickness tₘ, so that twist-phase matching is generated, and the efficiency of second harmonic generation thereof is higher than that of quasi-phase matching.

In the above embodiment where each two-dimensional material film has the same thickness, the relationship between the thickness t of the two-dimensional material film and the twist angle θ between adjacent two-dimensional material films is θ=Δk·t/3. In the above embodiment where the two-dimensional material films have different thicknesses, the relationship between the thickness t of the two-dimensional material films and the twist angle θₘ between adjacent two-dimensional material films is

$${θ}_{m} = Δ k ( {\sum }_{n = 1}^{m} {t}_{n} - \frac{1}{2} {t}_{m} - \frac{1}{2} {t}_{1} ) / 3.$$

However, for example, as shown in FIG. 2B, in the case where the thickness of the two-dimensional material films is greater than 5 nm, the nonlinear optical crystal structure formed by stacking the two-dimensional material films has higher tolerance to the twist angle, that is, the twist-phase matching can be achieved within a certain angle range, so that the output efficiency of nonlinear light can be enhanced. The inventors of the present invention have found that when the relationship between the thickness t of two-dimensional material film and the twist angle θₘ between adjacent two-dimensional material films is

$$\frac{11}{60} ( m - 1 ) Δ k \cdot t \leq {θ}_{m} \leq \frac{29}{60} ( m - 1 ) Δ k \cdot t ,$$

the output efficiency of second-order nonlinear light can also be enhanced. In the above embodiment where the two-dimensional material films have different thicknesses, when the relationship between the thickness t of two-dimensional material film and the twist angle θₘ between adjacent two-dimensional material films is

$$\frac{11}{60} Δ k ( {\sum }_{n = 1}^{m} {t}_{n} - \frac{1}{2} {t}_{m} - \frac{1}{2} {t}_{1} ) \leq {θ}_{m} \leq \frac{29}{60} Δ k ( {\sum }_{n = 1}^{m} {t}_{n} - \frac{1}{2} {t}_{m} - \frac{1}{2} {t}_{1} ) ,$$

the output efficiency of second-order nonlinear light can also be enhanced. It should be noted that the relation

$$\frac{11}{60} Δ k ( {\sum }_{n = 1}^{m} {t}_{n} - \frac{1}{2} {t}_{m} - \frac{1}{2} {t}_{1} ) \leq {θ}_{m} \leq \frac{29}{60} Δ k ( {\sum }_{n = 1}^{m} {t}_{n} - \frac{1}{2} {t}_{m} - \frac{1}{2} {t}_{1} )$$

can also be applied to the case where the thickness of each two-dimensional material film is the same. If tₙ, tₘ and t₁ are all set to the same value, the relation

$$\frac{11}{60} ( m - 1 ) Δ k \cdot t \leq {θ}_{m} \leq \frac{29}{60} ( m - 1 ) Δ k \cdot t$$

can be obtained.

In some embodiments, each two-dimensional material film has a crystal structure with a threefold rotational symmetry. In these embodiments, when the thickness t of each two-dimensional material film is equal to l_{c} and the interfilm twist angle is equal to 60 degrees, the enhancement effect of output efficiency of second-order nonlinear light equivalent to that of quasi-phase matching can be obtained. In addition, in some cases of the crystal structure with the threefold rotational symmetry, when the thickness of each two-dimensional material film is less than l_{c} and the interfilm twist angle is less than 60 degrees, good enhancement of the output efficiency of second-order nonlinear light can be achieved. Further, in the case where each two-dimensional material film has a crystal structure with a threefold rotational symmetry, the thickness thereof is less than l_{c} and the interfilm twist angle is less than 60 degrees, the enhancement of the output efficiency of second-order nonlinear light between that of quasi-phase matching and that of perfect-phase matching can be achieved by adjusting the thickness t of the two-dimensional material film and the interfilm twist angle θ to conform to the above-mentioned relationship between the thickness t of the two-dimensional material film and the twist angle between adjacent two-dimensional material films.

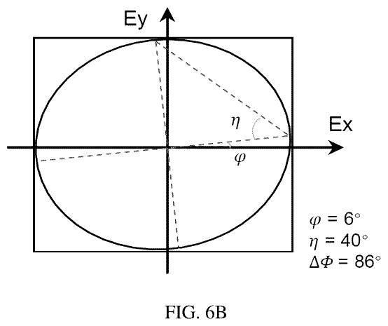

FIGS. 6A and 6B show that according to some other embodiments of the present disclosure, on the basis of the above embodiments, the output of nonlinear light with specific polarization conditions can be achieved by setting the total thickness of the nonlinear optical crystal structure. As shown in FIG. 6A, under the condition of setting the continuous twist angle θ, the total thickness of the nonlinear optical crystal structure is further set to T=c·t=n·l_{c}, where c and n are positive integers and l_{c} is the coherence length. If 3θ=+Δk·t is satisfied, the emergent second harmonic generation is right-handed circularly polarized light; If 3θ=−Δk·t is satisfied, the emergent second harmonic generation is left-handed circularly polarized light. FIG. 6A is a schematic diagram of an input light, an output light and a nonlinear optical crystal structure, and FIG. 6B is the experimental measurement result of this embodiment. In FIG. 6B, the phase difference ΔΦ between Ex and Ey is 86 degrees, and the ellipticity η is 40 degrees. As can be seen from FIG. 6B, by stacking two thick two-dimensional material films and keeping the twist angle as 3θ=+Δk·t or 3θ=−Δk·t, second harmonic generation with circular polarization (the test result in FIG. 6B shows elliptical polarization close to circular polarization) can be output after linearly polarized light passes through the nonlinear optical crystal structure. In addition, the polarization direction of the circularly polarized light can be further controlled by controlling the twist direction of adjacent two-dimensional material films.

It should be noted that the signs “+” and “−” in the conditions of 3θ=+Δk·t and 3θ=−Δk·t described in connection with the embodiments of FIGS. 6A and 6B here indicate the twist direction, and a positive twist angle and a negative twist angle are reversed in twist direction. For example, a positive twist angle indicates counterclockwise twisting, and a negative twist angle indicates clockwise twisting; or, a positive twist angle indicates clockwise twisting, and a negative twist angle indicates counterclockwise twisting. Therefore, as an exemplary continuous twist-angle structure, the twist angles are all positive, or the twist angles are all negative. However, it should be noted that, for the convenience of description, an angle value or an angle range without “+” and “−” signs can be considered as an absolute value of the twist angle or an absolute value range of the twist angle, in the case where the twist direction is specified (for example, the twist direction is the same) or the twist direction is not specified. Therefore, the twist direction of adjacent two-dimensional material films can be changed according to needs or in combination with other conditions. Therefore, the conditions of the nonlinear optical crystal structure for converting linear polarization into circular polarization in a specific direction can also be that the total thickness of the nonlinear optical crystal structure is T=c·t=n·l_{c} and 3θ=Δk·t. According to the direction of circular polarization to be achieved, the twist direction of the two-dimensional material films can be determined, or which side of the nonlinear optical crystal structure the incident light enters from can be determined.

The embodiments shown in FIGS. 6A and 6B adopt a structure in which the thickness t of each two-dimensional material film is the same, but the structure that can realize the conversion from linearly polarized light to circularly polarized light is not limited to the structure with the same thickness t. In some embodiments, at least two of the plurality of two-dimensional material films have different thicknesses, and the effect of converting linearly polarized light into circularly polarized light can also be achieved under the following conditions: the twist angle θₘ satisfies:

$${θ}_{m} = Δ k ( {\sum }_{n = 1}^{m} {t}_{n} - \frac{1}{2} {t}_{m} - \frac{1}{2} {t}_{1} ) / 3 ,$$

and thicknesses of the two-dimensional material films satisfy:

$${\sum }_{p = 1}^{N} exp ( - 2 i Δ k {\sum }_{n = 1}^{p - 1} {t}_{n} ) [ exp ( - i Δ k \frac{3}{2} {t}_{p} ) - exp ( - i Δ k \frac{1}{2} {t}_{p} ) ] = 0 ,$$

where p is an integer greater than or equal to 1 and less than or equal to N, and tₚ is a thickness of a p-th two-dimensional material film.

In the above embodiments, the thickness of each two-dimensional material film may be less than the coherence length l_{c}. However, the nonlinear optical crystal structure according to the embodiment of the present disclosure is not limited to this case, and the thickness of at least one of the plurality of two-dimensional material films included in the nonlinear optical crystal structure can be greater than the coherence length, and in this case, by setting the relationship between the thickness of the two-dimensional material film and the twist angle between adjacent two-dimensional material films, the nonlinear optical crystal structure can also enhance the output efficiency of nonlinear light.

In some embodiments, the coherence length l_{c} of the crystal material used for the two-dimensional material film is greater than 0 and less than or equal to 1 mm. In some examples, the coherence length can be in the range from 10 nm to 100 μm.

As some examples, the wave-vector mismatch of two-dimensional materials used to construct the nonlinear optical crystal structure in the second-order nonlinear optical effect is Δk (Δk=k3−k2−k1, that is, the difference between the wave vector of the emergent light and the wave vector of the incident light), and the film thickness or polarization period of the structure of the above-mentioned optical crystal when achieving quasi-phase matching to enhance the second-order nonlinear optical effect quasi-phase matching can be calculated by t=m1*l_{c}=m1*π/Δk, where m1 is an odd number and l_{c} is the coherence length (the coherence length l_{c} is a characteristic distance at which the nonlinear light can be enhanced, l_{c}=π/Δk). Each thick film is stacked with a specific twist angle, and quasi-phase matching can be achieved, thus effectively enhancing the second harmonic generation. The above twist angle needs to cause the polarization direction between thick films to reverse. If the symmetry of the crystal is n-fold rotational symmetry, the twist angle of the periodic structure for achieving quasi-phase matching is 180/n*m2 degrees, where m2 is an odd number.

In some examples, the periodic structure further includes a plurality of periods and quasi-periods.

In some embodiments, the thickness of each two-dimensional material film is substantially equal to the coherence length l_{c}, and the twist angle between adjacent two-dimensional material films is in the range from 51 degrees to 69 degrees. Under these conditions, the enhancement of the output efficiency of nonlinear light can also be achieved, and the quasi-phase matching can be achieved.

In the above embodiments, the second harmonic generation is described as an example. However, the embodiments of the present disclosure are not limited thereto. The nonlinear optical crystal structure according to the embodiments of the present disclosure can be applied to second-order nonlinear optical effects including second harmonic generation, sum frequency generation and difference frequency generation. According to the embodiments of the present disclosure, through twist-angle stacking of thick two-dimensional material films, the wave-vector mismatch Δk of second-order nonlinear light can be compensated, thereby realizing high-efficiency output of second harmonic generation, sum frequency generation or difference frequency generation. For the second harmonic generation, the wave-vector mismatch is Δk=k(2ω)−2k(ω); for the sum frequency generation and the difference frequency generation, the wave-vector mismatch is Δk=k(ω3)−k(ω2)−k(ω1), where ω, ω1 and ω2 are the frequencies of incident light, and 2ω and ω3 are the frequencies of emergent light.

For example, in combination with the types of materials of the two-dimensional material film that can be adopted by the nonlinear optical crystal of the embodiment of the present disclosure, as well as the types of modulated light used, in some embodiments, the above-mentioned wave-vector mismatch Δk is in the range of 10³-10⁹ m⁻¹. For example, the nonlinear optical crystal according to the embodiment of the present disclosure may be suitable for modulated light with a wavelength range from 400 nm to 6 μm, but it is not limited thereto.

Furthermore, although only second harmonic generation, sum frequency generation and difference frequency generation in second-order nonlinear optics are described in the above embodiments, the nonlinear optical crystal structure according to the embodiments of the present disclosure can also achieve the enhancement of the output efficiency of third-order nonlinear harmonic wave or higher-order nonlinear harmonic wave through twist-angle stacking of thick two-dimensional material films, as long as the thickness and twist angle are adjusted according to the respective optical characteristics thereof. For example, the nonlinear optical crystal according to the embodiments of the present disclosure can also achieve third harmonic generation, and the implementation method is as follows: the third harmonic generation can be achieved by coupling two second-order nonlinear processes, namely the second harmonic generation (SHG) and the sum frequency generation (SFG). In this case, the twist angle needs to be configured to compensate the wave-vector mismatch of the second harmonic generation and the wave-vector mismatch of the sum frequency generation at the same time, that is, for the second harmonic generation,

$$Δ {k}_{1} = \frac{4 π}{λ} ( n ( 2 ω ) - n ( ω ) ) ,$$

where λ is the wavelength of the incident light; for the sum frequency generation,

$$Δ {k}_{2} = 2 π ( \frac{n ( {ω}_{1} )}{{λ}_{1}} - \frac{n ( {ω}_{2} )}{{λ}_{2}} - \frac{n ( {ω}_{3} )}{{λ}_{3}} ) ,$$

where ω₁=ω, ω₂=2ω, ω₃=3ω, and λ₁, λ₂, λ₃ are the wavelengths of the corresponding frequencies.

For example, the second-order nonlinear optical coefficient of the two-dimensional optical crystal film can be greater than or equal to 0.01 pm/V. In this case, better output efficiency of second-order nonlinear light can be achieved. However, the embodiments of the present disclosure are not limited thereto.

Some embodiments of the present disclosure further provide a nonlinear light modulation method, which includes modulating light by using the nonlinear optical crystal structure of any of the above embodiments: light is incident from a first main surface of the nonlinear optical crystal structure and emitted from a second main surface, wherein the nonlinear optical crystal can be the nonlinear optical crystal structure provided by any of the above embodiments of the present invention. It should be noted that the nonlinear light modulation method of the embodiments of the present disclosure can modulate light by using the optical crystal of any of the above embodiments, so as to output nonlinear light with high efficiency. Therefore, the features of any of the above embodiments can be combined into the nonlinear optical modulation method, and the details are not repeated here.

For example, the incident light can be linearly polarized light or circularly polarized light, but it is not limited thereto.

For example, the wavelength of the incident light can be in the range from 400 nm to 6 μm.

The embodiments of the present disclosure mainly adopt a two-dimensional material nonlinear optical system, and utilize parameters such as twist angle, film thickness, and stacking, etc., to provide a new approach for constructing a nonlinear enhanced optical system, which can easily achieve high-efficiency output of second harmonic generation, sum frequency generation or difference frequency generation, as well as polarization control.

The nonlinear optical crystal structure according to the embodiments of the present disclosure can obtain at least one of the following technical effects.

Compared with the traditional quasi-phase matching based on positive and negative polarization, the non-classical phase matching based on twist-angle stacking makes full use of the advantage of controllable twist angle at the van der Waals interface of two-dimensional materials, so that the polarization direction can be adjusted according to the twist angle. At the same time, it also makes full use of the symmetry of different point groups of two-dimensional materials to provide rich means to control the intensity and polarization of second-order nonlinear optics.

Compared with the traditional optical crystal, the nonlinear optical crystal structure based on two-dimensional materials have ultra-high nonlinear coefficients, as well as the advantages of extremely thin thickness and silicon process compatibility, and is expected to become the core material of the next generation of optical chips and micro lasers.

There are many kinds of two-dimensional materials, and two-dimensional materials with different bandgaps and different functions can be obtained by means of growth and stripping, etc. Therefore, a nonlinear optical crystal structure system suitable for different bands and having different thresholds and different nonlinear coefficients can be obtained through different kinds of two-dimensional materials, which greatly meets the purpose of effectively enhancing second harmonic generation, sum frequency generation or difference frequency generation in different bands and fully flexibly adjusting polarization.

The theory of twist-phase matching is proposed and applied, and the continuous twist-angle structure is used to achieve higher conversion efficiency of second harmonic generation, sum frequency generation or difference frequency generation than traditional quasi-phase matching. According to the actual situation, corresponding twist angles can be designed according to different film thicknesses and film numbers of materials, and the high-efficiency output of second harmonic generation, sum frequency generation or difference frequency generation can be flexibly achieved.

It should be noted that only the structures relevant to the embodiments of the present invention are involved in the accompanying drawings of the embodiments of the present invention, and other structures may refer to common designs. In case of no conflict, features in one embodiment or in different embodiments of the present disclosure can be combined.

The foregoing is merely exemplary embodiments of the invention, but is not used to limit the protection scope of the invention. The protection scope of the invention shall be defined by the attached claims.

1. A nonlinear optical crystal structure, comprising a plurality of two-dimensional material films, wherein the plurality of two-dimensional material films are stacked in a direction perpendicular to a two-dimensional plane thereof, and two-dimensional material films adjacent to each other are bonded by van der Waals forces,
each of the plurality of two-dimensional material films is a crystal with a center-inversion-asymmetric crystal structure, and has a predetermined lattice orientation parallel to the two-dimensional plane in a direction parallel to the two-dimensional plane,
there is a non-zero twist angle between the two-dimensional material films adjacent to each other, and the twist angle is an included angle between predetermined lattice orientations of the two-dimensional material films adjacent to each other in the same two-dimensional plane, and
a thickness of each of the plurality of two-dimensional material films is greater than 5 nm.

2. The nonlinear optical crystal structure according to claim 1, wherein a wave-vector mismatch of a second-order nonlinear optical effect of the two-dimensional material film is Δk, and the nonlinear optical crystal structure comprises N two-dimensional material films, wherein a twist angle θₘ of an m-th two-dimensional material film relative to a first two-dimensional material film satisfies:
$$\frac{11}{60} Δ k ( {\sum }_{n = 1}^{m} {t}_{n} - \frac{1}{2} {t}_{m} - \frac{1}{2} {t}_{1} ) \leq {θ}_{m} \leq \frac{29}{60} Δ k ( {\sum }_{n = 1}^{m} {t}_{n} - \frac{1}{2} {t}_{m} - \frac{1}{2} {t}_{1} ) ,$$
where tₙ is a thickness of an n-th two-dimensional material film, tₘ is a thickness of the m-th two-dimensional material film, t₁ is a thickness of the first two-dimensional material film, N is an integer greater than or equal to 2, n is an integer greater than or equal to 1 and less than or equal to N, and m is an integer greater than 1 and less than or equal to N.

3. The nonlinear optical crystal structure according to claim 2, wherein the plurality of two-dimensional material films are equal in thickness and each has a thickness t, and the twist angle θₘ of the m-th two-dimensional material film relative to the first two-dimensional material film satisfies:
$$\frac{11}{60} ( m - 1 ) Δ k \cdot t \leq {θ}_{m} \leq \frac{29}{60} ( m - 1 ) Δ k \cdot t .$$

4. The nonlinear optical crystal structure according to claim 2, wherein the thickness of each of the plurality of two-dimensional material films is less than or equal to a coherence length l_{c}, and the coherence length l_{c} is a characteristic distance of enhancement of nonlinear light in the crystal with the center-inversion-asymmetric crystal structure.

5. The nonlinear optical crystal structure according to claim 4, wherein the twist angle between the two-dimensional material films adjacent to each other is less than or equal to 60 degrees.

6. The nonlinear optical crystal structure according to claim 2, wherein a thickness of at least one of the plurality of two-dimensional material films is greater than a coherence length l_{c}, and the coherence length l_{c} is a characteristic distance of enhancement of nonlinear light in the crystal with the center-inversion-asymmetric crystal structure.

7. The nonlinear optical crystal structure according to claim 2, wherein a twist direction of the m-th two-dimensional material film relative to a (m-1)-th two-dimensional material film is the same for every value of m.

8. The nonlinear optical crystal structure according to claim 3, wherein a total thickness of the plurality of two-dimensional material films is an integer multiple of a coherence length l_{c}, the coherence length l_{c} is a characteristic distance of enhancement of nonlinear light in the crystal with the center-inversion-asymmetric crystal structure, and the twist angle between the two-dimensional material films adjacent to each other is:
θ=Δk·t/3.

9. The nonlinear optical crystal structure according to claim 2, wherein at least two of the plurality of two-dimensional material films have different thicknesses, and the twist angle θₘ further satisfies:
$${θ}_{m} = Δ k ( {\sum }_{n = 1}^{m} {t}_{n} - \frac{1}{2} {t}_{m} - \frac{1}{2} {t}_{1} ) / 3 ,$$
and thicknesses of the plurality of two-dimensional material films satisfy:
$${\sum }_{p = 1}^{N} exp ( - 2 i Δ k {\sum }_{n = 1}^{p - 1} {t}_{n} ) [ exp ( - i Δ k \frac{3}{2} {t}_{p} ) - exp ( - i Δ k \frac{1}{2} {t}_{p} ) ] = 0 ,$$
where p is an integer greater than or equal to 1 and less than or equal to N, and tₚ is a thickness of a p-th two-dimensional material film.

10. The nonlinear optical crystal structure according to claim 2, wherein the wave-vector mismatch Δk is in a range from 10³ m⁻¹ to 10⁹ m⁻¹.

11. The nonlinear optical crystal structure according to claim 1, wherein the thickness of each of the plurality of two-dimensional material films is substantially equal to a coherence length l_{c}, the coherence length l_{c} is a characteristic distance of enhancement of nonlinear light in the crystal with the center-inversion-asymmetric crystal structure, and the twist angle between the two-dimensional material films adjacent to each other is in a range from 51 degrees to 69 degrees.

12. The nonlinear optical crystal structure according to claim 1, wherein each of the plurality of two-dimensional material films has a crystal structure with a threefold rotational symmetry.

13. The nonlinear optical crystal structure according to claim 1, wherein each of the plurality of two-dimensional material films comprises a plurality of sub-layers, each of the plurality of sub-layers has a same crystal structure with a parallel orientation,
the plurality of sub-layers comprise a first type sub-layer and a second type sub-layer, chemical bonds formed between atoms at corresponding lattice positions of the first type sub-layer and the second type sub-layer are in opposite directions, and a count of films of the first type sub-layers is greater than a count of films of the second type sub-layers; or chemical bonds formed between atoms at corresponding lattice positions of the plurality of sub-layers are all in a same direction.

14. The nonlinear optical crystal structure according to claim 12, wherein the count of films of the first type sub-layers accounts for more than 60% of a total count of films of the plurality of sub-layers.

15. The nonlinear optical crystal structure according to claim 1, wherein a second-order nonlinear optical coefficient of the crystal with the center-inversion-asymmetric crystal structure is not less than 0.01 pm/V.

16. The nonlinear optical crystal structure according to claim 1, wherein a material of the plurality of two-dimensional material films comprises any one selected from the group consisting of boron nitride, transition metal chalcogenide, palladium selenide, niobium oxide diiodide or niobium oxide dichloride.

17. The nonlinear optical crystal structure according to claim 2, wherein the second-order nonlinear optical effect comprises second harmonic generation, sum frequency generation and difference frequency generation.

18. The nonlinear optical crystal structure according to claim 4, wherein the coherence length l_{c} is less than 1 mm.

19. The nonlinear optical crystal structure according to claim 2, wherein the twist angle is configured to simultaneously compensate the wave vector mismatch of second harmonic generation and sum frequency generation.
